(19) United States
(12) Patent Application Publication
(10) Pub. No.: US 2001/0039650 A1
(43) Pub. Date: Nov. 8, 2001

(54) Method in a software controlled system

(76) Inventor: Bela Bodo, Tyreso (SE)

Correspondence Address: Ronald L. Grudziecki, Burns, Doane, Swecker & Mathis, L.L.P., P.O. Box 1404, Alexandria, VA, 22313-1404, US

(21) Appl. No.: 09/736,324

(22) Filed: Dec. 15, 2000

(30) Foreign Application Priority Data
Dec. 17, 1999 (SE) 9904646-8

(51) Int. Cl. G06F 9/44

(52) U.S. Cl. 717/4

(57) ABSTRACT

The present invention relates generally to a method of facilitating the tracing of errors in the software load modules of a computer-controlled system. More particularly, the method is implemented in systems with software originating from compiling processes in version-controlling environments. A record created during such a compiling process is stored in a version controlling system. The path and version of the record thus stored is bundled with the load module so that it may be easily retrieved in order to facilitate debugging operations.

### TECHNICAL FIELD OF THE INVENTION

The present invention relates generally to a method of facilitating the tracing of errors in the software of a software-controlled system. More particularly, the method is implemented in systems with software originating from compiling processes in version-controlling environments.

### DESCRIPTION OF RELATED ART

Telecommunications systems, as well as other complex electronics systems, are being designed, to an increasing extent, to be software controlled. This renders these systems less expensive and more flexible, since a certain hardware platform may then be adapted to different applications by providing it with different software. Moreover, it becomes easier to provide an existing system, such as for instance a telecommunication switch, with new functionality; this may often be done simply by providing new software versions.

The software that is applied to such a system is often called a load module. A load module is a set of executable files that are created by compiling and linking a large number of source-code files. Creating a new version of a load module then typically involves writing new source code files and modifying or removing others as compared to a previous load module version. The source code files are then compiled and linked to form the new load module version.

This kind of development work is in most cases performed in a so-called version controlling system. A reason for this is the complexity of the software used. A load module may be built from thousands of source code files, together involving millions of lines of code. Dozens of programmers may be involved simultaneously and they may be located at different sites. A version controlling system then keeps up with changes and serves to avoid version conflicts. An example of such a version control system is CLEARCASE. Version controlling systems are described in inter alia U.S. Pat. No. 5,574,898 and U.S. Pat. No. 5,649,200.

When a new version of a load module is applied to a computerised system, unforeseen errors often occur when the system is run. To isolate and trace such an error is both tedious and difficult.

A known method to trace an error in a software-controlled system is to analyse a so-called dump. A dump in this sense consists of the content of the respective computer memories at the time when the system ceased to operate correctly. With this information as a starting point an attempt can be made to decide which part of the executable code caused the error and which source code file corresponds to this piece of executable code. This is a complicated procedure, which requires intelligent guessing from the person tracing the error.

The fact that there may be different hardware platforms causes further problems. There may perhaps be only one software-hardware combination that invokes the problem. It should also be mentioned that there may be dozens of versions, utilised simultaneously at different sites, and that probably no person involved knows exactly which source code versions have been changed between two consecutive load module versions and how. This of course also applies to the person or persons performing error-tracing activities.

### SUMMARY OF THE INVENTION

An object of the present invention is therefore to provide a method for facilitating error tracing in the software of a computer system.

Another object of the invention is to allow a faster tracing of errors in a software-controlled system.

These objects are achieved by implementing a method in accordance with the invention, which is now described.

When source code files controlled by, for instance, a CLEARCASE system are built, i.e. compiled and linked into a load module a so-called configuration record is created. The configuration record describes which source code files are included in the build process and their version numbers.

In accordance with the inventive method, the configuration record is stored in a version control system. The configuration record may then be unambiguously retrieved by providing its path and version number. The path and the version number of the configuration record are bundled with the relevant load module. This allows a programmer, trying to trace an error in a load module, to easily and unambiguously retrieve the relevant configuration record. By comparing this record with the configuration record of an earlier used load module, the programmer may quickly find out which source code files differs between two load modules. If the earlier used load module version functioned properly it is likely that the error is to be found in one of these source code files. The error tracing or debugging activities may therefore be substantially simplified.

This method is also useful when tracing errors in function library files, which are not executable per se.

### DESCRIPTION OF THE DRAWINGS

FIG. 1 illustrates, schematically, a software development environment in accordance with known art.

FIG. 2 is a flow-chart, which defines essential steps according to a first embodiment of the invention.

FIG. 3 is a flow-chart, which defines essential steps according to another embodiment of the invention.

### DESCRIPTION OF PREFERRED EMBODIMENTS

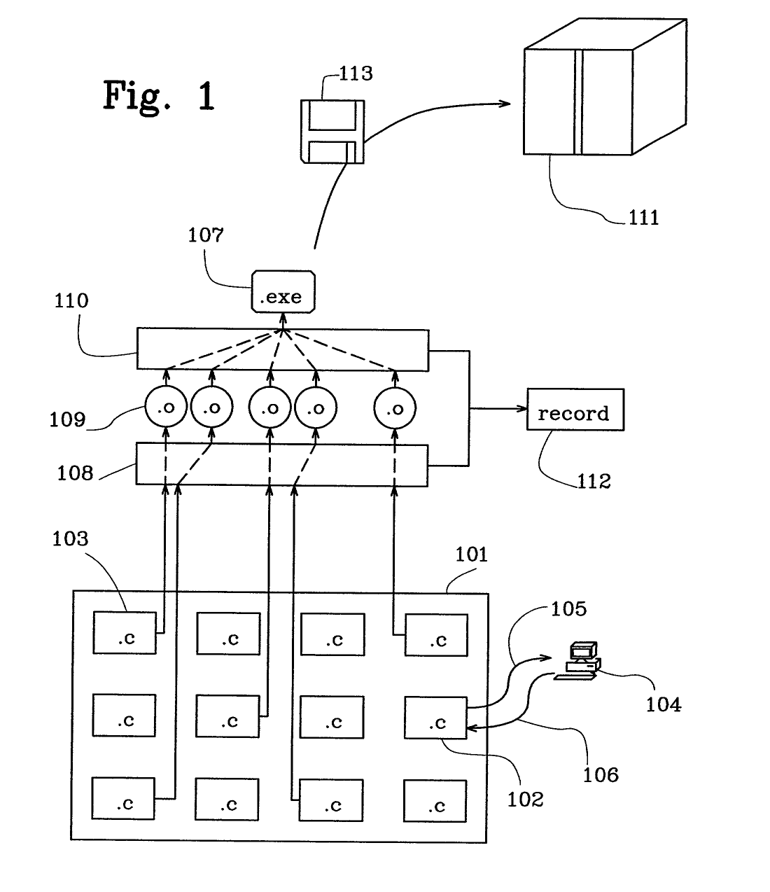

FIG. 1 illustrates, schematically, a software development environment in accordance with known art. It includes a version controlling system 101, wherein a large number of source code files 102, 103 are stored. A programmer wishing to modify, on a computer 104 at his site, a source code file with a specific version number must perform a checkout procedure 105 from the version controlling system in order to do so. When the working session is finished the file is returned in a check-in procedure 106 to the version controlling system and is assigned a unique version number different from the version number of the file once checked out. This serves to avoid version conflicts, for instance, when two programmers work on a source code file simultaneously. If a first and a second programmer check out a file two different version branches are created as the respective files are checked back into the system.

The source code files 102, 103 may be written in any high level programming language such as C, C++, PASCAL, JAVA etc. In a case where the source code files are written in C, they are usually given the suffix “.c” in order to be recognised as C-files by the system. When a load module 107 is created in a build process, selected source code files are collected from the version controlling systems to be compiled. In a compilation process 108 each selected source code file 103 is translated into a machine-readable code. The file 109 thus created is often called an object file and is normally given the same name as its corresponding source code file but with a different suffix: “.o”.

In the next step the object files are linked in a linking process 110 into a single executable file 107, often carrying the suffix “.exe”. This file, which forms a load module, is then loaded at a remote site where it provides certain features to a system 111. The load module may be sent over a network or by means of a computer readable medium 113.

As an alternative, the linking process 110 may be set to produce a relocatable module (not shown). This file is not directly executable, but may be linked again together with other files to produce an executable load module.

In some computer aided software engineering systems (CASE), such as CLEARCASE, a record 112 is created during the build process which specifies the source code files included in the load module and their respective version numbers.

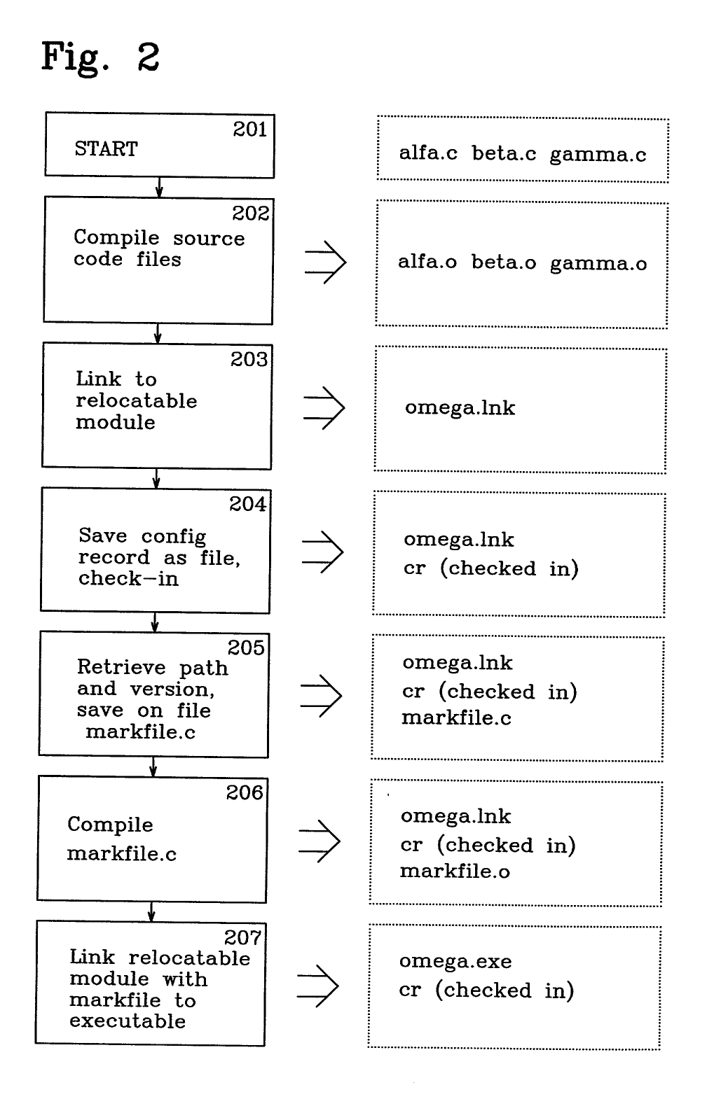

FIG. 2, which is a flow-chart defining essential steps according to a first embodiment of the invention, is now described in detail. The commands described below are relevant in a UNIX environment where CLEARCASE is used as a development tool. A number of steps included in the method according to the embodiment of the invention are shown at the left-hand side of the drawing. The corresponding results of the respective steps are denoted in the dotted boxes at the right hand side of the drawing.

When the building process is to start 201 three source code files; alfa.c, beta.c and gamma.c; are at hand in this simple example. These source code files are written in C, hence their suffix. In a first step 202 these files are compiled with the following instruction.

> cc -c alfa.c beta.c gamma.c

This results in corresponding object files. In a second step the object files are linked into a relocatable module omega.lnk.

> ld -r alfa.o beta.o gamma.o -o omega.lnk -L/usr/lib -lc

A relocatable module, which carries the suffix “.lnk”, may be linked again in order to include more functionality. In a third step 204 the configuration record which was created during the first two steps 202, 203 is saved and checked into a version controlling system.

> cleartool checkin -cr -from omega.lnk cr

In a fourth step 205, the path to and version number of the file containing the configuration record are retrieved and saved, preferably as global variables, in a file, which is written in C.

> CR_VERSION=‘cleartool ls cr’

> sed s/CR_VERSION/$CR_VERSION/ markfile.c.skel>markfile.tmp

> CR_PATH=‘pwd’

> sed s/CR_PATH/$CR_PATH/ markfile.tmp>markfile.c

In this example markfile.c.skel is a template wherein CR_VERSION is a string. In the first “sed s” command above this string is replaced by the variable $CR_VERSION which has been assigned the version number of the configuration record as stored in a version controlling system. This template is then saved as markfile.tmp. Similarly, in the second “sed s” command above a string CR_PATH is replaced by the variable $CR_PATH which is assigned the path of the configuration record as stored. For the path to be correct the operative system should be set to the directory in which the configuration record is stored. The file markfile.tmp is then saved as markfile.c.

In a fifth step 206, this c-file is compiled:

> cc -c markfile.c

This results in a corresponding object file. This file is then linked 207 together with the relocatable module into an executable module.

> ld omega.lnk markfile.o -o omega.exe L/usr/lib -lc

The file containing the path and version number of the configuration record is thus bundled into the executable file. This results in an executable file that may be run in a device at a remote site. The path and version number of the saved configuration may easily be retrieved at the remote site.

In a preferred embodiment of the method, the C-file containing the path and version number of the configuration record is written using so-called “what-strings”, written as “@(#)”. This means that the C-file may be written as:

const char BUILD_SUPPORT_LM_PATH[ ]=“@(#) /vobs/foo/foo_lm”;

const char BUILD_SUPPORT_LM_VERS[ ]=“@(#) cr@@/main/17”;

In this case the path to the configuration record stored in the version control system is “/vobs/foo/foo_lm” and the version number is “cr@@/main/17”. They are defined as global string variables. If such a C-file is used, the path and version number may be retrieved offline in a UNIX environment at the site where the load module is used by typing, where a.loadmodule is the name of the load module:

>what a.loadmodule

This results in the system giving the following information:

/vobs/foo/foo_lm

cr@@/main/17

The path and version number may also be retrieved online, i.e. when running the load module, at the site where the load module is used. In that case the load module has to provide functionality to retrieve the values with commands from its management system.

Provided with this information, the person performing the error tracing activities can unambiguously retrieve the correct configuration record. By comparing this record with the record of a functioning earlier version of the same load module it is relatively easy to find out which source code files have been changed. Those files are excellent starting points when trying to find the error/errors.

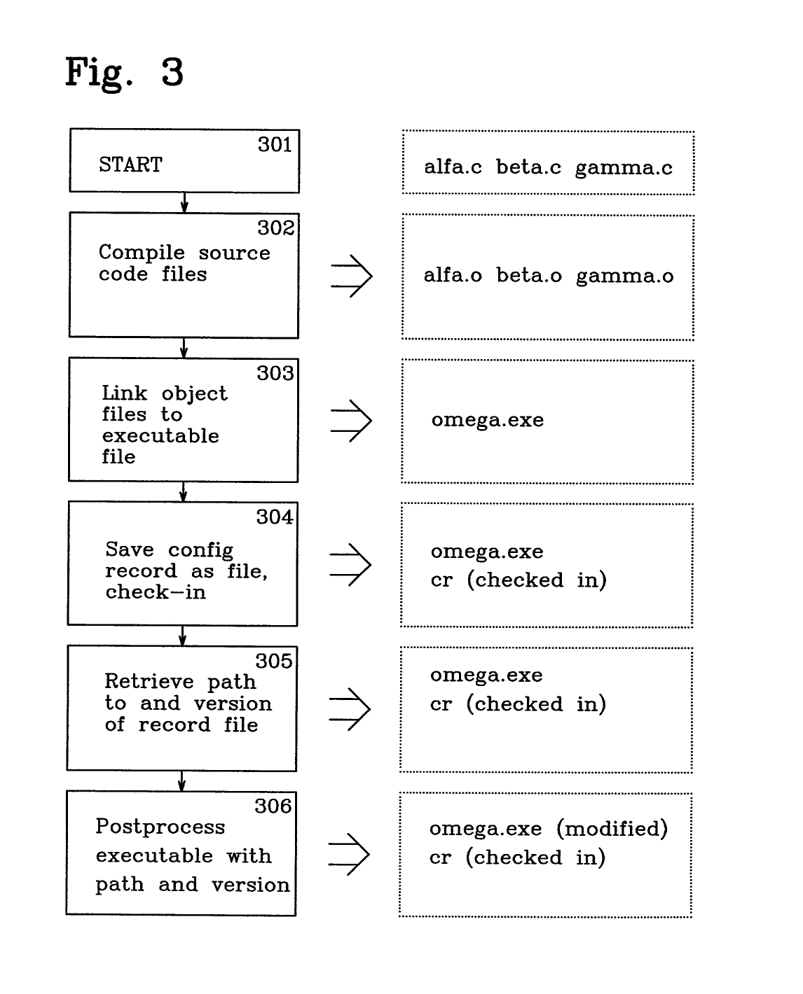

It should be noted that there are other ways of bundling the path and version numbers with an executable. Some CASE systems allows post-processing of executables. Then the relevant information may be entered into the executable without extra compilation and linking processes. Such a method is described in FIG. 3.

As in the earlier described example, three source code files that are to be used are present when the process starts 301. These source code files, alfa.c, beta.c and gamma.c are compiled 302 into the object files alfa.o, beta.o and gamma.o. Then the object files are linked into an executable file named omega.exe. The configuration record produced during the compilation 302 and linking 303 steps is saved and checked into a version controlling system 304. The version of and the path to the configuration record thus stored are retrieved in another step 305. In a final step the executable file is post-processed together with the path and version information in a manner so that the information may be retrieved at the site where the executable load module is to be used.

The executable load module, when completed, may be stored on a computer readable medium or it may be transmitted to the remote site via a network. It is also possible to load the executable onto a circuit such as a PROM-circuit. A load module created in accordance with the inventive method may thus be utilised in a so-called boot-PROM, which is used to load other load modules into a system during start-up.

The method according to the invention may also be used when building function library software files, preferably then in the manner described in connection with FIG. 2. Then, during the final step 207, the relocatable module is linked with the object file, which contains path and version of the configuration record into a file of the type .lib. In that case, however, the path and version may of course only be retrieved offline.

1. A method of facilitating the tracing of errors in executable software of a computer controlled system, wherein said software is achieved in a building process, i.e. the compiling (202; 302) and linking (203; 303) of a number of source-code files which are stored in a version controlling system, and wherein at least a part of said building process furthermore results in a record which specifies names and versions of source-code files included in said building process characterised in the following steps:
storing (204;304) said record in a version controlling system,
retrieving (205; 305) path and version number of the record thus stored, and
bundling (206, 207; 306) said path and version number with said executable software in such a manner that said path and version number is retrievable at the site where the executable software is to be used.

2. A method as claimed in claim 1 characterised in said bundling including the following step:
postprocessing (306) said executable file and thus integrating said executable file and said path and version number.

3. A method as claimed in claim 1 characterised in that said executable software is stored in a PROM circuit.

4. A method of facilitating the tracing of errors in executable software of a computer controlled system, wherein said software is achieved in a building process, i.e. the compiling and linking of a number of source-code files which are stored in a version controlling system, characterised in the following steps:
compiling (202) said source code files into object files,
linking (203) said object files into a relocatable module, wherein said compiling and linking steps also creates a record specifying names and versions of used source code files,
storing (204) said record in a version controlling system,
retrieving path and version of the record thus stored,
creating (205) a source code file where said path and version number are defined as global variables,
compiling (206) the source code file where said path and version number are defined as global variables,
linking (207) said relocatable together with said source code file where said path and version number are defined as global variables, into an executable file.

5. A method of facilitating the tracing of errors in function library software, wherein said function library software is achieved in a building process, i.e. the compiling and linking of a number of source-code files which are stored in a version controlling system, and wherein at least a part of said building process furthermore results in a record which specifies names and versions of source-code files included in said building process characterised in the following steps:
storing (204) said record in a version controlling system,
retrieving (205) path and version number of the record thus stored, and
bundling (206, 207) said path and version number with said function library software in such a manner that said path and version number is retrievable when the function library software is to be used.

6. A computer readable medium comprising, in compiled format, the following items defined as global string variables:
“@(#)X”; and
“@(#)Y”;
wherein X is the path and Y is the version number of a configuration record stored in a version control system
